(19) United States
(12) Patent Application Publication
(10) Pub. No.: US 2026/0164416 A1
(43) Pub. Date: Jun. 11, 2026

(54) DISCRETE FOURIER TRANSFORM SIZE DETERMINATION AND FREQUENCY DOMAIN RESOURCE ALLOCATION

(71) Applicant: InterDigital Patent Holdings, Inc., Wilmington, DE (US)

(72) Inventors: Young Woo Kwak, Woodbury, NY (US); Moon-il Lee, Melville, NY (US); Paul Marinier, Brossard (CA); Nazli Khan Beigi, Longueuil (CA)

(73) Assignee: InterDigital Patent Holdings, Inc., Wilmington, DE (US)

(21) Appl. No.: 18/707,351

(22) PCT Filed: Oct. 28, 2022
(86) PCT No.: PCT/US2022/048246

§ 371 Date: May 3, 2024

Related U.S. Application Data
(60) Provisional application No. 63/275,774, filed on Nov. 4, 2021.

(51) Int. Cl. H04W 72/0453; H04L 27/26; H04W 72/232

(52) U.S. Cl. CPC H04W 72/0453; H04L 27/2636; H04W 72/232

(57) ABSTRACT

Described herein are systems, methods and instrumentalities associated with receiving download transmissions using a single-carrier waveform. A number of sub-bandwidth parts (sub-BWPs) associated with a BWP may be configured for a WTRU and used by the WTRU to receive the downlink transmission. The WTRU may determine the sizes of the sub-BWPs and/or one or more discrete Fourier transform (DFT) sizes associated with the sub-BWPs, and receive the downlink transmission based at least on the sub-BWP sizes and/or the DFT sizes. The WTRU may further determine a precoding parameter associated with the downlink transmission based on the sub-BWP sizes and a network-indicated precoding parameter, and receive the downlink transmission further based on the determined precoding parameter.

### CROSS-REFERENCE TO RELATED APPLICATIONS

This application claims the benefit of Provisional U.S. Patent Application No. 63/275,774, filed Nov. 4, 2021, the disclosure of which is incorporated herein by reference in its entirety.

### BACKGROUND

In certain frequency bands such as higher frequency bands, efficient transmission power handling may be desirable, for example, since a high transmission power may be used in these frequency bands to overcome increased pathloss. Power amplifier efficiency may degrade as the frequency increases. Reduction in power backoff may be desirable, but orthogonal frequency domain multiplexing (e.g., such as cyclic prefix orthogonal frequency-division multiplexing (CP-OFDM)) in the downlink (DL) of a communication network (e.g., such as a new radio (NR) network) may be associated with a high peak-to-average power ratio (PAPR) and/or a corresponding large backoff for signal transmission. Single carrier waveforms may be used for higher frequency bands. Among candidate waveforms, discrete Fourier transform-spread-orthogonal frequency domain multiplexing (DFT-s-OFDM) may be supported in an NR uplink (UL) (e.g., for rank 1 transmissions) and/or a long-term evolution (LTE) UL. In the DL, application of DFT-s-OFDM including support for multiple access associated with a group of wireless transmit/receive units (WTRUs) may be investigated (e.g., since DFT-S-OFDM may not be flexible enough to support multiple WTRUs). N×single carrier-frequency domain multiple access (SC-FDMA) and/or clustered discrete Fourier transform-spread-orthogonal frequency domain multiple access (DFT-S-OFDMA) may be considered in the DL.

### SUMMARY

Described herein are systems, methods, and instrumentalities associated with downlink communication using a single-carrier waveform. A wireless transmit/receive unit (WTRU) in accordance with one or more embodiments described herein may include a processor configured to receive configuration information, wherein the configuration information may indicate a bandwidth part (BWP) and a number of sub-bandwidth parts (sub-BWPs) associated with the BWP, and wherein the number of sub-BWPs includes a first sub-BWP and a second-BWP. The processor may be further configured to determine, based at least on the configuration information, a first sub-BWP size and a first discrete Fourier transform (DFT) size associated with the first sub-BWP, and determine, based at least on the configuration information, a second sub-BWP size and a second DFT size associated with the second sub-BWP. The processor may be further configured to receive downlink control information (DCI) that may indicate that at least one of the first sub-BWP or the second sub-BWP may be used for receiving a downlink transmission such as a physical downlink shared channel (PDSCH) transmission, and the processor may receive the downlink transmission using the at least one of the first sub-BWP or the second sub-BWP, for example, by at least applying an inverse DFT to the transmission based on at least one of the first DFT size associated with the first sub-BWP or the second DFT size associated with the second sub-BWP.

In examples, the downlink transmission may be received via a single-carrier waveform, which may include a single carrier frequency division multiple access (SC-FDMA) waveform or a discrete Fourier transform spread orthogonal frequency division multiplexing (DFT-s-OFDM) waveform. In examples, the processor of the WTRU may be further configured to determine a frequency offset between the first sub-BWP and the second sub-BWP, and determine the first sub-BWP size and the second sub-BWP size further based on the frequency offset. In examples, the DCI described herein may further indicate a first precoding parameter (e.g., a precoding resource block group (PRG) size) associated with the downlink transmission, and the processor may be further configured to determine, based at least on the first precoding parameter and at least one of the first sub-BWP size or the second sub-BWP size, a second precoding parameter (e.g., a second PRG size) associated with the downlink transmission, which may be used to receive downlink transmission. The second PRG size may be determined to be greater than the first PRG size if the first PRG size is smaller than at least one of the first sub-BWP size or the second sub-BWP size. For instance, the second PRG size may be set to be the greater of the first sub-BWP size or the second sub-BWP size if the first PRG size is smaller than the first sub-BWP size and the second sub-BWP size. In examples, the WTRU may be configured with the first precoding parameter (e.g., via a radio resource control (RRC) message) before receiving the DCI that indicates the first precoding parameter.

In examples, the processor of the WTRU may be further configured to determine a timing parameter associated with the first sub-BWP or the second sub-BWP, wherein the timing parameter may be associated with at least one of a channel state information (CSI) report associated with the first sub-BWP or the second sub-BWP, a reference signal associated with the first sub-BWP or the second sub-BWP, a hybrid automatic repeat request (HARQ) feedback associated with the first sub-BWP or the second sub-BWP, or a transmission configuration indication (TCI) indication associated with the first sub-BWP or the second sub-BWP.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of N×SC-FDMA.

FIG. 3 is a diagram illustrating an example of clustered DFT-s-OFDMA.

FIG. 4 is a diagram illustrating example hybrid operations of N×SC-FDMA and clustered DFT-s-OFDM.

FIG. 5 is a diagram illustrating configuration and/or use of one or more sub-BWPs and a PRG for receiving a downlink transmission.

### DETAILED DESCRIPTION

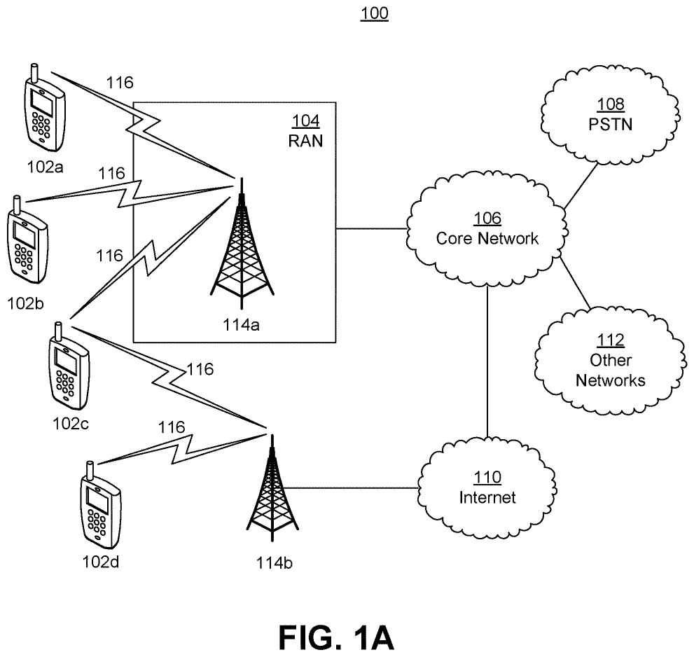

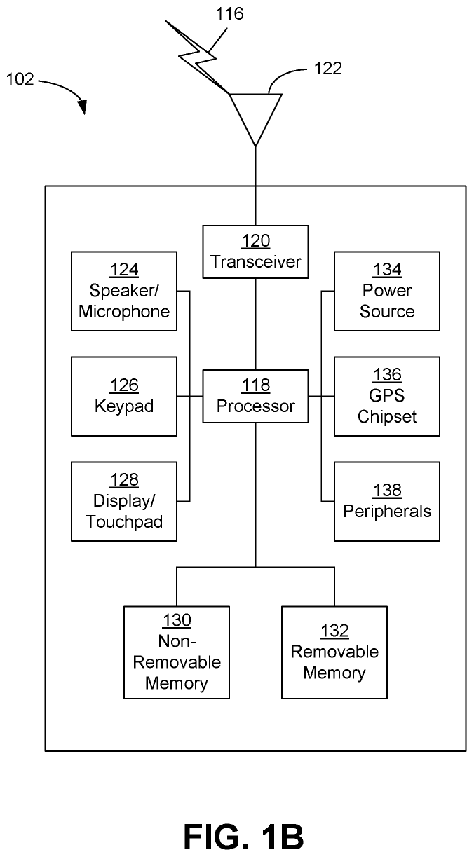

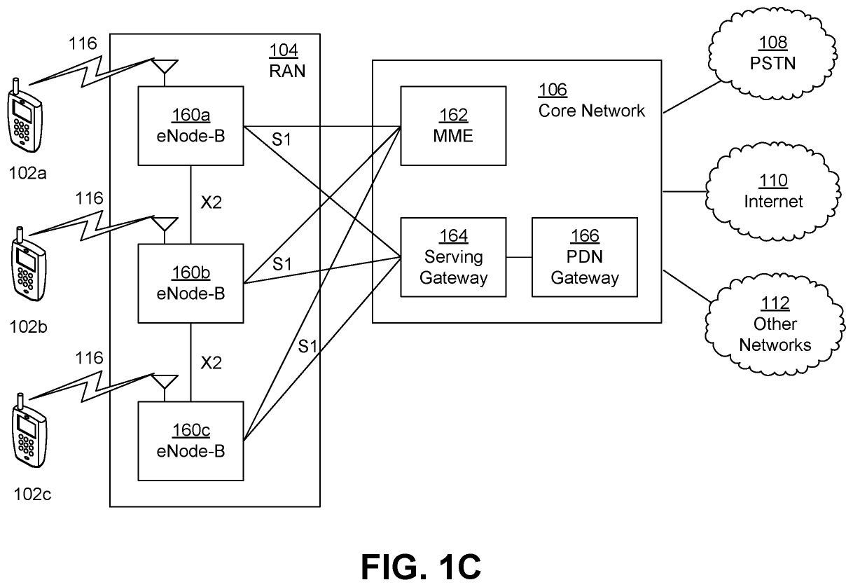

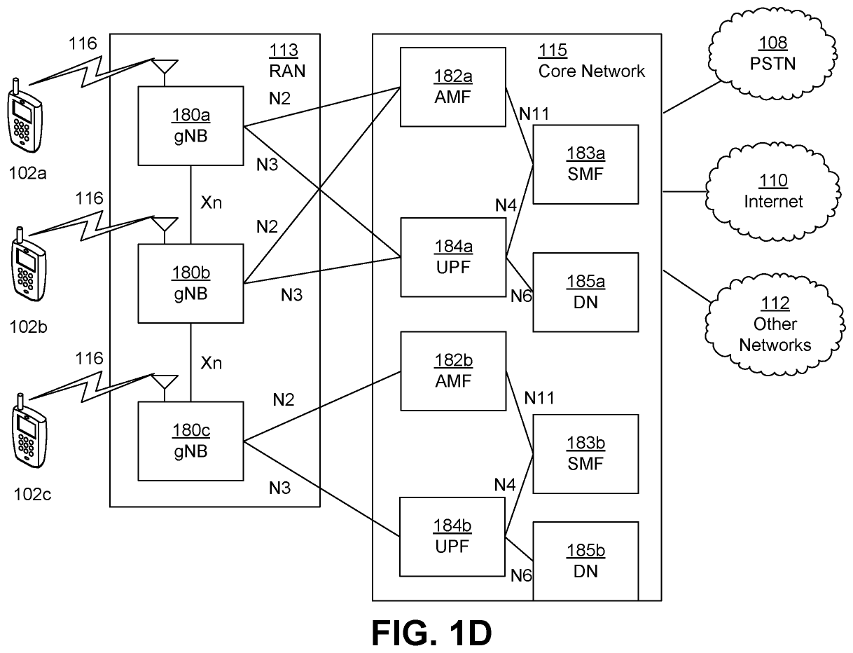

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In accordance with one or more embodiments described herein, operation parameters related to discrete Fourier transform (e.g., such as a DFT size and/or the number of clusters or sub-BWPs) may be dynamically determined. For example, an explicit indication of the DFT sizes and/or the number of clusters (e.g., sub-BWPs) may be provided using one or more of a radio resource control (RRC) message, a media access control (MAC) control element (CE), or downlink control information (DCI). An indication of a precoding parameter such as an indication of a precoder (or precoding) resource block group (PRG) may be provided for DFT size or cluster determination. Different candidate PRGs aligned with a DFT size may be supported. A WTRU may receive an indication of a PRG (e.g., a PRG size) and may use the PRG indication (e.g., PRG size) to determine a cluster size. A WTRU may receive configuration information regarding a DFT size, a cluster size, and/or a number of clusters associated with a frequency band (e.g., associated with a bandwidth part (BWP)). The WTRU may determine a number of clusters (e.g., which may be denoted as N herein) based on an indicated DFT size and/or an indicated cluster size.

A WTRU may be configured with one or more sub-BWPs (e.g., sub-parts of a BWP) to support multiple DFT sizes and/or clustering. While the terms BWP and sub-BWP may be used in the examples provided herein, those skilled in the art will appreciate that the examples may be applicable to any UL or DL frequency band (e.g., a carrier, a BWP, etc.) or sub-parts of that frequency band. The WTRU may be configured with a DFT size, a cluster size, a number of clusters or sub-BWPs per BWP, and/or a number of clusters per sub-BWP. A network (e.g., a base station or gNB) may activate and deactivate one or more sub-BWPs, for example, based on an activated or deactivated BWP. The WTRU may be configured (e.g., pre-configured) with a default DFT size for common operation (e.g., performed in specific symbols). The WTRU may be configured with a DFT size specific to the WTRU (e.g., a WTRU-specific DFT size). A DFT size may be configured based on slot formats and/or signals (e.g., based on a synchronization signal block (SSB) and/or a physical broadcast channel (PBCH) signal and/or based on an SSB based measurement timing configuration (SMTC) window). A DFT size may be configured for paging. The WTRU may be configured to apply an additional back off, for example, if the WTRU determines that a DFT size or a number of DFT block is configured. The additional back may be different based on the value of the DFT size or the number of DFT blocks configured.

In accordance with one or more embodiments described herein, a downlink transmission such as a physical downlink shared channel (PDSCH) transmission may be scheduled based on N×SC-FDMA and/or clustered DFT-s-OFDM. With respect to frequency domain resource allocation (FDRA), the allocation may be performed based on a resource block group (RBG). For a first set of allocation types (e.g., allocation type 0), the allocation may be performed based on nonconsecutive RBGs. For a second set of allocation types (e.g., allocation type 1), the allocation may be performed based on consecutive RBs (e.g., by indicating a starting resource block using RB_start, and/or indicating a number of consecutive RBs). Clustering based on other criteria or signals (e.g., SSBs, CORESET #0, reserved RBs, etc.) may be omitted. For example, if consecutive scheduling is supported, the WTRU may omit or skip one or more clusters associated with these other criteria or signals. The allocation (e.g., for allocation type 1) described herein may be performed based on a RBG or a number of consecutives RBGs.

FDRA may be performed using one or more of the following methods. FDRA may be performed based on multiple chunks of RBs. The multiple chunks may correspond to multiple starting RBs and/or the same or different lengths (e.g., the multiple chunks may include the same number of RBs or different numbers of RBs). A chunk (e.g., of the multiple chunks) may be associated with a starting RBG and/or a RBG length. A chunk (e.g., of the multiple chunks) may be associated with an RB and/or an RBG offset. FDRA may be performed based on a DCI such as a two-stage DCI. For example, a first DCI may indicate a DFT, a sub-BWP, and/or a cluster index, and a second DCI may indicate an RB allocation. FDRA may be performed based on a bitmap. For example, the bitmap may indicate different RBG sizes scaled by a number of clusters and/or a BWP size. The bitmap may indicate clusters and/or existing allocation types. FDRA may be performed based on a number of clusters, N, which may be determined based on a BWP size. FDRA may be performed based on a number of clusters, which may be determined based on a coverage condition of a WTRU (e.g., as indicated by a CSI feedback). FDRA may be performed based on an offset (e.g., a minimum offset) between clusters (e.g., between sub-BWPs).

PRG determination may be supported for a wideband (e.g., only for the wideband). A WTRU may use a determined DFT size or sub-BWP size as a PRG size, for example, if a network-configured or network-indicated PRG size is smaller than the determined DFT size or sub-BWP size. It should be noted that the DFT sizes, sub-BWP sizes, and PRG sizes may be defined using the same unit (e.g., RBs) or they may be defined using different units. In the latter case, when determining whether the PRG size is smaller than the determined DFT size or sub-BWP size, the sizes may be converted into a comparable unit first (e.g., into an actual bandwidth defined in Hz).

In accordance with one or more embodiments described herein, CSI reporting may be performed for N×SC-FDMA and/or clustered DFT-s-OFDM. Different CSI reporting parameters may be applied based on the number of clusters, N, and/or the properties of the clusters. Wideband and/or subband CSI reporting may be performed per DFT (e.g., for each DFT cluster). Power offsets, back-off values, and/or headroom may be indicated (e.g., per precoding matrix indicator (PMI)) in association with CSI reporting or CSI reporting configuration. A WTRU may report and/or recommend (e.g., to a network) a number of clusters (e.g., a number of sub-BWPs including respective sizes of the sub-BWPs), a DFT size, and/or a CSI report setting (e.g., including a waveform in the setting). CSI reporting may be performed based on clustered DFT-S-OFDM and/or N×DFT-S-OFDM. A WTRU may be configured with one or more wideband reports and/or a cluster configuration or set-up (e.g., a hierarchical cluster configuration). For example, cluster set-up #1 may correspond to RBG 1, 3, 5, cluster set-up #2 may correspond to RBG 2, 4, 6, etc. A subband size (e.g., a subband within a sub-BWP defined for CSI reporting purposes) may be determined based on a DFT size and/or a cluster size (e.g., a maximum or minimum DFT size and/or cluster size). In accordance with one or more embodiments described herein, a reference signal (RS) transmission may be performed for (e.g., based on) N×SC-FDMA and/or clustered DFT-s-OFDM.

A transmission spectrum of at least 5 GHz (e.g., between 57 and 64 GHz) may be available globally for unlicensed operation. In some countries, up to 14 GHz of spectrum (e.g., between 57 and 71 GHz) may be available for unlicensed operation. A spectrum of at least 10 GHz (e.g., between 71 and 76 GHz and/or between 81 and 86 GHz) may be available globally for licensed operation. In some countries, up to 18 GHz of spectrum (e.g., between 71 and 114.25 GHz) may be available for licensed operation. While frequency ranges above 52.6 GHz may potentially contain larger spectrum allocations and larger bandwidths that may not be available for bands lower than 52.6 GHz, physical layer channels may have been designed to optimize performance under 52.6 GHz. Table 1 and Table 2 below show available frequencies between 52.6 GHz and 71 GHz, and between 52.6 GHz and 71 GHz, respectively.

TABLE 1
available frequencies between 52.6 GHz and 71 GHz

| | | Frequency (GHz) | | | | | | | | | | |
|---|---|---|---|---|---|---|---|---|---|---|---|---|
| | | 52.6- | 54.25- | 55.78- | 56.9- | 57- | 58.2- | 59- | 59.3- | 64- | 65- | 66- |
| Region | Country | 54.25 | 55.78 | 56.9 | 57 | 58.2 | 59 | 59.3 | 64 | 65 | 66 | 71¹⁾ |
| ITU | Europe/CEPT | | | | | U (Mobile) | | | | | | |
| Region | Israel | | | | | | | | | | | |
| 1 | South Africa | | | | | U (Mobile) | | | | U (Mobile) | | |
| ITU | USA | | | | | U (Mobile) | | | | | | |
| Region | Canada | | | | | U (Mobile) | | | | | | |
| 2 | Brazil | | | | | U (Mobile) | | | | | | |
| | Mexico | | | | | U (Mobile) | | | | | | |
| ITU | China | | | | | | | U (Mobile) | | | | |
| Region | Japan | | | | | U (Mobile) | | | | | | |
| 3 | Korea | | | | | U (Mobile) | | | | | | |
| | India | | | | | | | | | | | |

| | |
|---|---|
| Taiwan | U (Mobile) |
| Singapore | U (Mobile) |
| Australia | U (Mobile) |

NOTE 1:
Access regime currently under discussion in CEPT

TABLE 2
available frequencies between 71 GHz and 100 GHz

| | | Frequency (GHz) | | | | | | | | | | |
|---|---|---|---|---|---|---|---|---|---|---|---|---|
| | | 71- | 74- | 76- | 77- | 81- | 84- | 86- | | 94- | | 95- |
| Region | Country | 74¹⁾ | 76¹⁾ | 77 | 81 | 84¹⁾ | 86¹⁾ | 92 | 92-94 | 94.1 | 94.1-95 | 100 |
| ITU | Europe/CEPT | L (Fixed) | | | | L (Fixed) | | | L (Fixed) | L (Fixed) | | |
| Region | Israel | | | | | | | | | | | |
| 1 | South Africa | L (Fixed) | | | | L (Fixed) | | | | | | |
| ITU | USA | L (Fixed/Mobile) | | | | L (Fixed/Mobile) | | | L (Fixed/ | | L (Fixed/ | |
| Region | | | | | | | | | Mobile) | | Mobile) | |
| 2 | Canada | L (Fixed) | | | | L (Fixed) | | | | | | |
| | Brazil | L (Fixed) | | | | L (Fixed) | | | | | | |
| | Mexico | L (Fixed) | | | | L (Fixed) | | | | | | |
| ITU | China | | | | | | | | | | | |
| Region | Japan | L (Fixed) | | | | L (Fixed) | | | | | | |
| 3 | Korea | L (Fixed) | | | | L (Fixed) | | | | | | |
| | India | | | | | | | | | | | |
| | Taiwan | L(Fixed) | | | | L (Fixed) | | | | | | |
| | Singapore | L (Fixed) | | | | L (Fixed) | | | | | | |
| | Australia | | | | | | | | | | | |

Note 1:
Candidate frequency band for IMT identification under WRC-19 Al 1.13

Communication performed using frequencies above 52.6 GHz may face challenges, such as higher phase noise, extreme propagation loss (e.g., due to high atmospheric absorption), lower power amplifier efficiency, and/or strong power spectral density regulatory requirements. Efficient transmission power handling may be desirable, for example, since a high transmission power may be used to overcome increased pathloss in higher frequency bands. Power amplifier efficiency may degrade as frequency increases. Given the degraded power amplifier efficiency, reduction pf power backoff may be desirable for wireless communication in those higher frequency bands. Cyclic prefix-orthogonal frequency domain multiplexing (CP-OFDM) in the downlink (DL) of a communication system (e.g., an NR system) may be performed with a high peak-to-average power ratio (PAPR) and/or a corresponding large backoff for signal transmission. Single carrier (SC) waveforms may be used for higher frequency bands. Among candidate SC waveforms, DFT-s-OFDM may be a suitable choice as DFT-s-OFDM may already be supported for uplink communications (e.g., in an NR uplink such as for rank 1 transmissions, and/or an LTE uplink) in multiple (e.g., all) transmission layers. The application of DFT-s-OFDM in a downlink may include support for multiple access (e.g., by multiple WTRUs). DFT-s-OFDM, however, may not be flexible enough to support multiple WTRUs. N×SC-FDMA and/or DFT-s-OFDMA may be used to support multiple access (e.g., by multiple WTRUs) in a downlink. For example, N×SC-FDMA may enable transmission to multiple WTRUs by supporting independent DFT precoding for a (e.g., each) subband while clustered DFT-s-OFDMA may allow multiple WTRU transmissions by supporting multiple frequency domain chunks (e.g., sub-BWPs) with a frequency domain gap or offset between two chunks, and/or an application of a chunk specific filter (e.g., a bandpass filter for removing potential interference from one chunk to other chunks).

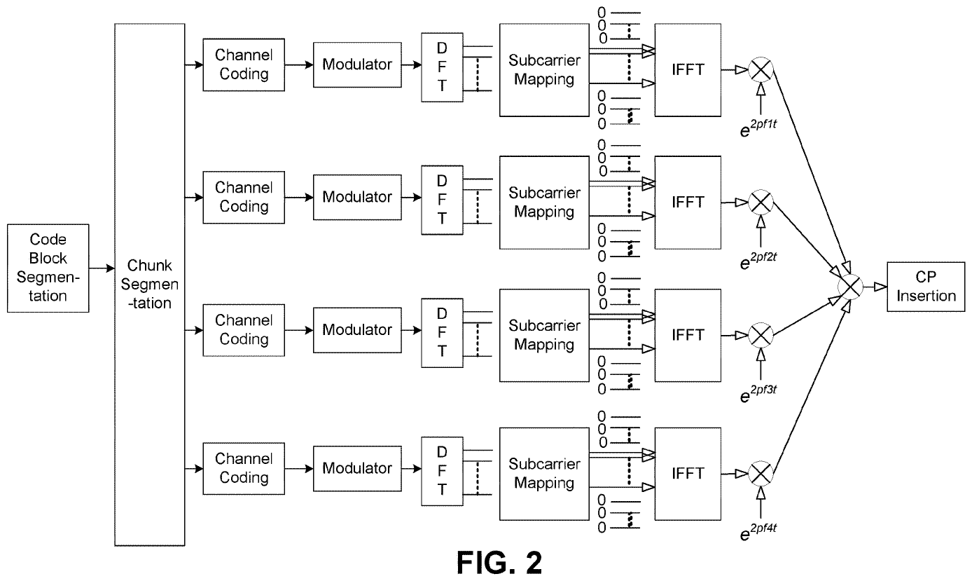

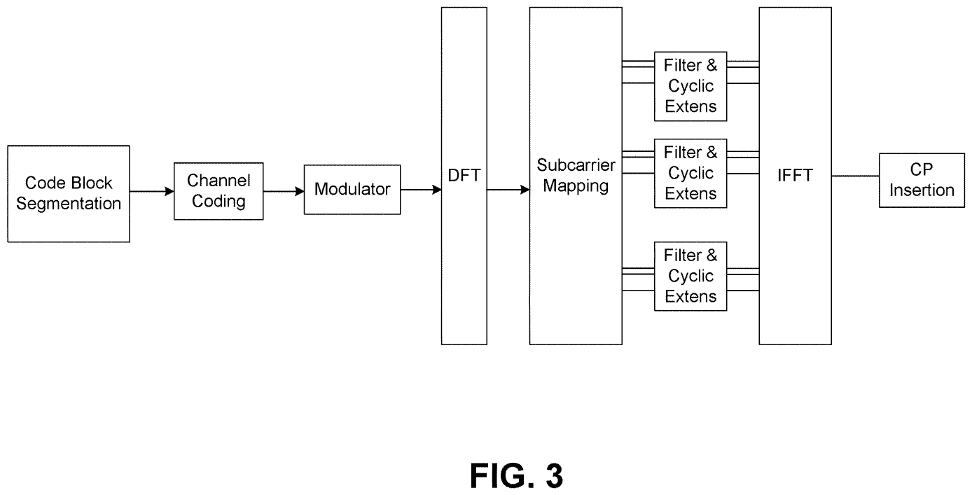

FIG. 2 illustrates an example of N×SC-FDMA, and FIG. 3 illustrates an example of clustered DFT-s-OFDMA. One or more of the following may be enabled and/or performed. Dynamic determination of a DFT size and/or clusters (e.g., based on sub-BWPs) may be enabled. Physical downlink shared channel (PDSCH) scheduling may be performed based on N×SC-FDMA and/or clustered DFT-s-OFDM. CSI reporting for N×SC-FDMA and/or clustered DFT-s-OFDM may be enabled. RS transmission for N×SC-FDMA and/or clustered DFT-s-OFDM may be enabled.

A WRU may transmit or receive a physical channel transmission or a reference signal transmission based on at least one spatial domain filter. The term “beam” may be used herein to refer to a spatial domain filter. The WTRU may perform a physical channel transmission or a reference signal (including an SSB) transmission using the same spatial domain filter as the spatial domain filter used for performing a physical channel or reference signal reception (e.g., such as a CSI-RS or a SS block). A transmission by the WTRU may be referred to as a “target”, while a reception (e.g., a received RS or SS block) may be referred to as a “reference” or “source.” Using these terminologies, the WTRU may be said to transmit a target physical channel or reference signal according to a spatial relation with an RS or SS block.

A WTRU may perform a first physical channel or a first reference signal (including an SSB) transmission using the same spatial domain filter as the spatial domain filter used for performing a second physical channel or reference signal transmission. The first and second transmissions may be referred to as a “target” and a “reference” (or a “source”), respectively. Using these terminologies, the WTRU may be said to perform the first (e.g., target) physical channel or reference signal transmission according to a spatial relation with the second (e.g., reference) physical channel or reference signal transmission.

A spatial relation between two beams or spatial filters may be determined implicitly or explicitly (e.g., configured via RRC signaling and/or indicated by a MAC CE or DCI). For example, a WTRU may implicitly transmit a physical uplink shared channel (PUSCH) transmission and/or a DM-RS associated with the PUSCH according to the same spatial domain filter as a sounding reference signal (SRS) indicated by an SRS resource indicator (SRI) indicated in DCI or configured via RRC signaling. As another example, a spatial relation may be configured via RRC signaling (e.g., for an SRI) or signaled by a MAC CE for a physical uplink control channel (PUCCH). Such a spatial relation may also be referred to as a beam indication.

A WTRU may receive a first (e.g., target) downlink channel or signal according to the same spatial domain filter or spatial reception parameter as a second (e.g., reference) downlink channel or signal. For example, an association may exist between a physical channel (e.g., such as a physical downlink control channel (PDCCH) or a physical downlink shared channel (PDSCH)) and a DM-RS. Such an association may exist, for example, at least when the first and second signals are reference signals and/or when the WTRU is configured with a quasi-colocation (QCL) assumption type D between corresponding antenna ports. Such an association may be configured as a TCI (transmission configuration indicator) state. The WTRU may be informed about an association between a CSI-RS (or an SS block) and a DM-RS by an index to a set of TCI states configured via RRC signaling and/or signaled by a MAC CE. Such an indication may also be referred to as a beam indication.

A DFT size and/or a number of clusters associated with a downlink transmission such as a PDSCH transmission may be determined dynamically. When referred to herein, a signal may include (e.g., be interchangeably used with) one or more of following: a sounding reference signal (SRS), a channel state information reference signal (CSI-RS), a demodulation reference signal (DM-RS), a phase tracking reference signal (PT-RS), or a synchronization signal block (SSB). When referred to herein, a channel may include (e.g., be interchangeably used with) one or more of following: a PDCCH, a PDSCH, a PUCCH, a PUSCH, a physical random access channel (PRACH), etc. The term “DFT” may be interchangeably used with transform precoding.

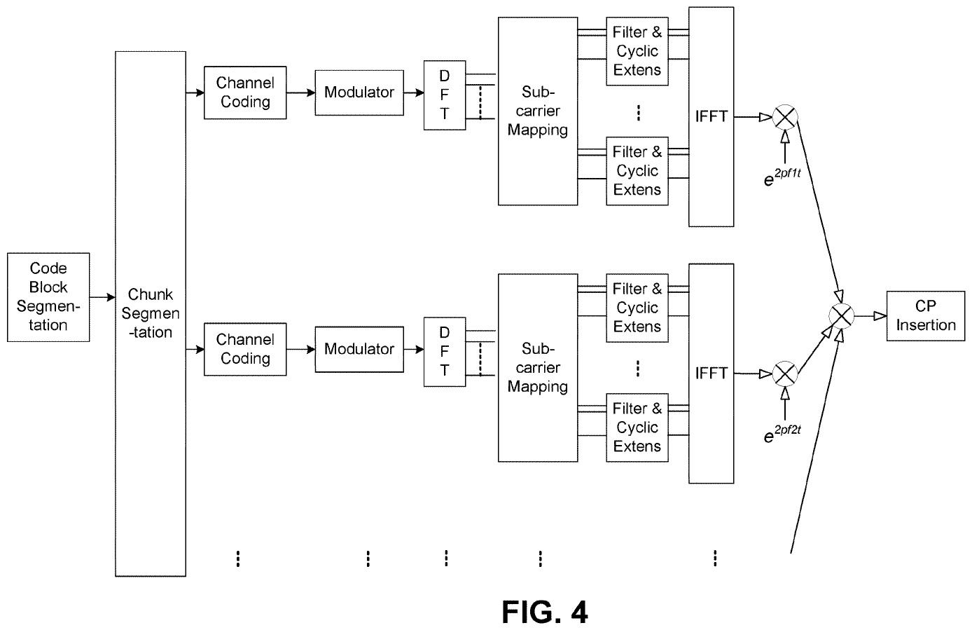

In examples, a WTRU may receive a dynamic indication (e.g., an explicit indication) of a DFT size for N×SC-FDMA and/or a number of clusters for clustered DFT-s-OFDM. In examples, the WTRU may determine the DFT size for N×SC-FDMA and/or the number of clusters for clustered DFT-s-OFDM based on other configuration information received by the WTRU. The WTRU may perform a hybrid operation of N×SC-FDMA and clustered DFT-s-OFDM based on the indicated or determined DFT size and/or number of clusters. FIG. 4 illustrates example hybrid operations of N×SC-FDMA and clustered DFT-s-OFDM. The WTRU may receive or determine the DFT size and/or the number of clusters based on one or more of following. In examples (e.g., if a single-carrier based waveform such as clustered DFT-s-OFDM, N×SC-FDMA, or DFT-s-OFDM is used), one or more DFT precoders may be used for a set of modulated symbols that may be mapped onto a set of subcarriers scheduled for one or more WTRUs before IFFT and CP insertion. A cluster as described herein may be used for the single-carrier based waveform and may refer to one or more of the following. The cluster may refer to (e.g., if multiple clusters are configured for a sub-BWP and/or if a single DFT precoder is used for a set of modulated symbols for the WTRU) a subset of modulated symbols that may be mapped to consecutive subcarriers in a frequency band (e.g., a local subcarrier group, a subcarriers belonging to consecutive RBs, etc.), or the cluster may refer to (e.g., if multiple clusters are configured within a sub-BWP) a local subcarrier group that may be used for DL/UL transmission. In these cases, the number of clusters may correspond to the number of subsets of modulated symbols that may be mapped to different local subcarrier groups. The cluster may refer to (e.g., if multiple clusters are configured within a sub-BWP and/or if one or more DFT precoders are used for a set of modulated symbols for the WTRU) a subset of modulated symbols associated with the same DFT precoder, wherein the cluster may be associated with one of the one or more DFT precoders. For example, if N DFT precoders are used for a waveform (e.g., N×SC-FDMA), it may be considered that N clusters are used for the waveform.

The term “DFT precoder” may be interchangeably used herein with a DFT spreader, a DFT block, a DFT process, a DFT operation, and/or a DFT pre-processing operation. The term “cluster” may be interchangeably used with a sub-BWP (e.g., if a BWP is configured with multiple sub-BWP or clusters), a subcarrier group, a local subcarrier group, a frequency resource group, an RB group, a PRB group, and/or consecutive PBR groups.

In examples, a WTRU may indicate a first maximum number of clusters supported by the WTRU for a waveform as a capability of the WTRU and a base station (e.g., a gNB) may configure (e.g., via RRC signaling) or indicate (e.g., via DCI or a MAC CE) a second maximum number of clusters for uplink and/or downlink scheduling. The WTRU may assume that it may not be scheduled for a downlink and/or an uplink with more than the maximum number of clusters in a BWP or a carrier, wherein the maximum number of clusters may be the first maximum number of clusters indicated by the WTRU (e.g., as a capability of the WTRU) or the second maximum number of clusters configured or indicated by the base station (e.g., a gNB). One or more of following may apply.

In a DCI (e.g., a scheduling DCI such as DCI format 0_0, 0_1, 1_0, and/or 1_1), the number of bits in a frequency domain resource allocation (FDRA) field may be determined based on the maximum number of clusters (e.g., the second maximum number of clusters described above). When multiple waveforms (e.g., clustered DFT-s-OFDM and N×SC-FDMA) are used, the WTRU may indicate the first maximum number of clusters (e.g., as described above) per waveform individually. In examples, a maximum number of clusters for a waveform may be implicitly determined based on one or more of following. The maximum number of clusters may be determined based on one or more system parameters including but not limited to a maximum DL transmission power, a bandwidth of a carrier or a BWP associated with the carrier or BWP, a number of RBs for the associated carrier/BWP, a coverage of the cell, a number of carriers, a number of BWPs, a frequency range, a subcarrier spacing, a CP length, a slot length, and/or a cell-ID. The maximum number of clusters may be determined based on WTRU capabilities including but not limited to a WTRU power class, a number of Tx and/or Rx antennas, a supportable bandwidth, a beam correspondence, and/or a maximum number of layers. The maximum number of clusters may be determined based on an SSB index or a coverage level of the WTRU. For example, one or more coverage levels may be used, and each coverage level may be associated with a maximum number of clusters and/or be determined based on a DL measurement, a WTRU location, and/or a configuration provided by a base station (e.g., a gNB).

In examples, a WTRU may be indicated (e.g., receive an indication regarding) the number of clusters used, determined, and/or configured for a downlink and/or uplink transmission. The indication may be provided via a higher layer signaling (e.g., in a system information block (SIB), via RRC signaling, and/or in a MAC-CE) or in a DCI that may schedule the downlink and/or uplink transmission. The WTRU's behaviors may be based on the number of clusters determined.

The processing time of a WTRU for a transmission or reception may be defined in various ways. For example, the processing time may be defined as a time duration between the first uplink symbol associated with a HARQ ACK PUCCH and the end of the last symbol associated with a PDSCH. The processing time may also be defined as a beam/TCI state switching time, a BWP or sub-BWP switching time, a PUSCH preparation time, a CSI processing time, etc. In examples, the processing time (e.g., a minimum processing time) for a downlink channel and/or a reference signal (e.g., a PDSCH transmission or a reference signal transmission) may be determined based on at least one of following. The processing time may be determined based on the number of clusters indicated or used for the downlink channel (e.g., PDSCH). For example, a first minimum WTRU processing time may be used or determined if the number of clusters used for a downlink transmission is less than a threshold, and a second minimum WTRU processing time may be used or determined if the number of clusters used for the downlink transmission is equal to or more than the threshold. The threshold may be determined based on one or more of a MCS level used, a number of RBs allocated, a subcarrier spacing, a BWP-id, or a physical cell-id. The threshold may be configured per waveform. The processing time may be determined based on a DFT size of a cluster. For example, if a DFT size of at least one of the clusters is larger than a threshold, a first minimum WTRU processing time may be used or determined. If a DFT size of at least one of the clusters is smaller than the threshold, a second minimum WTRU processing time may be used or determined. The processing time may be determined based on a maximum DFT size of one or more clusters used for a downlink transmission. The processing time may be determined based on a modulation order (or MCS) used for a downlink transmission. The processing time may be determined based on a subcarrier spacing and/or a frequency range.

One or more of following may apply based on a determined minimum WTRU processing time. HARQ-ACK reporting timing may be determined based on the minimum WTRU processing time. The HARQ-ACK timing for a downlink transmission (e.g., a PDSCH transmission) may be referred to as n+k1, wherein n may be a slot wherein the WTRU may receive the PDSCH transmission (or its associated PDCCH transmission) and k1 may be a slot offset in which the WTRU may send a HARQ-ACK. For example, a first set of HARQ-ACK timing parameters (e.g., k1={2, . . . , 32}) may be used to indicate HARQ-ACK timing if the received PDSCH is associated with a number of clusters above a threshold, and a second set of HARQ-ACK timing parameters (e.g., k1={0, 1, 2, . . . , 32}) may be used to indicate HARQ-ACK timing if the received PDSCH is associated with a number of clusters below the threshold. The minimum value of HARQ-ACK timing may be limited based on the number of clusters used for a downlink transmission. The WTRU may drop a HARQ-ACK reporting or send dummy information in an associated HARQ feedback, for example, if the WTRU receives a HARQ-ACK timing parameter that is less than the determined minimum WTRU processing time, or if the received HARQ-ACK timing parameter is not within a set of timing parameters configured for the WTRU.

A DFT size may be determined for a RBG based on a resource allocation. For example, a WTRU may be scheduled to receive a downlink signal (e.g., a PDSCH transmission) based on a resource block group (RBG) and a bitmap associated with the RBG. Each bit of the bitmap may indicate whether an RBG associated with the bit may be used for a channel (e.g., a PDSCH and/or a PUSCH). For example, if the bit is 0, then the associated RBG may not be used for the channel, and if the bit is 1, then the associated RBG may be used for the channel. An RBG may include a set of contiguous RBs and the number of RBs for the RBG may be determined based on at least one of a total number of RBs for a BWP, a configuration for a BWP, and/or a waveform used or determined.

In examples, a DFT block may be associated with one or more RBGs. For example, if a BWP includes K RBGs, K DFT blocks may be used (e.g., a DFT block may be associated with a respective RBG) and a WTRU may be scheduled with multiple (e.g., all) of the RBGs for a downlink transmission. In these examples, the number of DFT blocks used for a downlink transmission may correspond to the number of RBGs scheduled for the downlink transmission, and one or more of following may apply. A DFT block size may be determined based on the number of RBGs scheduled within a set of RBGs associated with the DFT block. For example, each RBG may include n1 RBs and each RB may include 12 subcarriers. The DFT block size may be determined as n1×12×n2, where n2 may be the number of RBGs scheduled and associated with the DFT block. A maximum DFT block size may be determined based on the number of RBGs associated with a DFT block. For example, if a (e.g., each) DFT block is associated with n3 RBGs, the maximum DFT block size may be determined as n1×12×n3, where n3>=n2. If n3 RBGs are associated with a DFT block (e.g., n3>2) and if a subset of RBGs is used for a downlink or an uplink transmission, the subset of RBGs may be consecutive in the frequency domain. The association between a DFT block and one or more RBGs may be configured (e.g., via RRC signaling), predetermined, or dynamically determined or indicated (e.g., via DCI) for a WTRU. The association may be fixed or dynamic. In an example of a fixed association, if 6 RBGs are determined for a BWP as {RBG #0, RBG #1, RBG #2, RBG #3, RBG #4, RBG #5}, three DFT blocks {DFT #0, DFT #1, DFT #2} may be associated with the 6 RBGs as {DFT #0: (RBG #0, RBG #1), DFT #1: (RBG #2, RBG #3), DFT #2: (RBG #4, RBG #5)}. If the WTRU is scheduled with {RBG #1 and RBG #2}, two DFT blocks (e.g., DFT #0 and DFT #1) may be used by the WTRU. In an example of a dynamic association, if 6 RBGs are determined or used for a BWP as {RBG #0, RBG #1, RBG #2, RBG #3, RBG #4, RBG #5} and three DFT blocks {DFT #0, DFT #1, DFT #2} are used as a maximum, each DFT block may be associated with up to 2 RBGs. If the WTRU is scheduled with {RBG #1 and RBG #2}, one DFT block (e.g., DFT #0) may be used by the WTRU. A DFT block may be associated with a BWP configured for the WTRU. For example, a single DFT block may be associated with one or more RBGs and a DFT size may be determined based on the number of RBGs scheduled for the WTRU.

A DFT size may be determined based on a precoder (or precoding) resource block group (PRG). A WTRU may determine a DFT size and/or a cluster size based on an indicated PRG size. The WTRU may be configured with one or more PRG candidates (e.g., 2 PRBs, 4 PRBs, a wideband, etc.), for example, via a PRG configuration or indication. Based on the one or more PRG candidates, the WTRU may receive an indication of a PRG for transmitting and/or receiving a channel and/or a reference signal (e.g., including an SSB). For example, the WTRU may receive one of the one or more PRG candidates (e.g., via one or more of DCI, a MAC CE, or an RRC message) for transmitting and/or receiving channels and/or reference signals. Based on the PRG size, the WTRU may estimate a channel by jointly estimating DMRS ports within a PRG and the WTRU may decode the channel for a downlink. For an uplink, the WTRU may apply a same precoding for DMRS ports within a PRG. The DFT size and/or cluster size may be determined based on a following equation.

$${N}_{SC}^{DFT} = {N}_{SC}^{RB} \times {N}_{PRG}$$

where

$${N}_{SC}^{DFT}$$

may be a determined DFT size,

$${N}_{SC}^{RB}$$

may be a number of subcarriers in an RB (e.g., 12), and N_{PRG} may be an indicated PRG size for a BWP or a sub-BWP.

A DFT size or a number of clusters may be configured per BWP or per sub-BWP. A DFT size may be interchangeably used herein with a cluster size, and a number of clusters may be interchangeably used herein with a number of DFTs. One or more DFT sizes and/or one or more numbers of clusters may be configured for a BWP. For example, a first DFT size and/or a first number of clusters may be used, configured, or determined for a first BWP (or sub-BWP) and a second DFT size and/or a second number of clusters may be used, configured, or determined for a second BWP (or a second sub-BWP). If a WTRU transmits and/or receives one or more channels and/or reference signals (e.g., including an SSB) in a BWP (or a sub-BWP), the WTRU may use the determined DFT size and/or the number of clusters for the BWP (or sub-BWP) to transmit and/or receive the one or more channels and/or reference signals within the BWP (or sub-BWP).

One or more DFT sizes and/or one or more numbers of clusters for a BWP may be implicitly determined based on one or more properties of the BWP. The one or more properties may include at least one of a subcarrier spacing, a bandwidth, a number of RBs, a BWP identity, whether the BWP includes an SSB, or whether the BWP includes a cell-defining SSB. For example, a WTRU may determine a first number of DFT size and/or a first number of clusters for a BWP if the bandwidth (or the number of RBs) for the BWP is larger than a threshold. The WTRU may determine a second number of DFT size and/or a second number of clusters for the BWP if the bandwidth (or the number of RBs) for the BWP is equal to or smaller than the threshold. If a BWP is larger than a threshold, a larger DFT size and/or a larger number of clusters may be used, for example, to multiplex more WTRUs. If the BWP is smaller than the threshold, a smaller DFT size and/or a smaller number of clusters may be used, for example, to reduce a PAPR. The WTRU may determine a first number of DFT sizes and/or a first number of clusters for an initial BWP (e.g., a default BWP), for example, to reduce a PAPR and/or to support better coverage. The WTRU may determine a second number of DFT size and/or a second number of clusters for other BWPs, for example, to multiplex more WTRUs based on at least one property of the BWP(s) and/or a higher layer configuration.

A DFT size and/or a number of clusters may be determined based on a measurement or reporting performed by a WTRU. For example, the WTRU may measure one or more reference signals to determine the DFT size and/or the number of clusters. The one or more reference signals may include one or more of a SSB, a CSI-RS, a DM-RS, or an SRS, and the measurement may include one or more of a reference signal received power (RSRP), a reference signal received quality (RSRQ), a reference signal strength indicator (RSSI), a signal to noise ratio (SINR), a channel quality indicator (CQI), etc. Based on the measurement, the WTRU may determine the DFT size and/or the number of clusters. For example, if the measurement (e.g., result or quality of the measurement) is lower than (or equal to) a threshold, the WTRU may determine a first DFT size and/or a first number of clusters. If the measurement (e.g., result or quality of the measurement) is higher than the threshold, the WTRU may determine a second DFT size and/or a second number of clusters. The threshold may be a predefined value, a value configured by a network (e.g., by a base station or gNB), or a value reported by the WTRU (e.g., via WTRU capability signaling). The WTRU may use two or more thresholds to determine three or more DFT sizes and/or numbers of clusters. The reporting described above may be performed based on one or more of channel state information (CSI), radio link monitoring (RLM), radio resource management (RRM), etc. The reporting may be performed via one or more of a PUCCH, a PUSCH, or a PRACH. The WTRU may receive a confirmation from a network (e.g., from a base station or gNB) on the value of the DFT size(s) and/or number(s) of clusters reported by the WTRU. The confirmation may be received via one or more of a PDCCH, a PDSCH, a reference signal, etc.

One or more sub-BWPs may be configured to support multiple DFTs (e.g., multiple DFT sizes) and/or a number of clusters. The one or more sub-BWPs may be configured for a BWP (e.g., associated with the BWP). A WTRU may receive information activating one or more sub-BWPs in an activated BWP based on or more of RRC signaling, a MAC CE, or a DCI. The WTRU may receive information deactivating one or more sub-BWPs in a deactivated BWP based on or more of RRC signaling, a MAC CE, or a DCI. The WTRU may transmit and/or receive reference signals (e.g., including an SSB) and/or channels based on the activation or deactivation information. For example, the WTRU may receive an indication to active a first sub-BWP of an active BWP. Based on the activation, the WTRU may transmit and/or receive channels and/or reference signals in the first sub-BWP of the active BWP.

One or more DFT sizes and/or one or more numbers of clusters may be configured for a sub-BWP. For example, a first DFT size and/or a first number of clusters may be used, configured, or determined for a first sub-BWP, and a second DFT size and/or a second number of clusters may be used, configured, or determined for a second sub-BWP. When a WTRU transmits and/or receives a channel and/or a reference signal in a sub-BWP, the WTRU may use the determined DFT size and/or number of clusters for the sub-BWP to transmit and/or receive the channel and/or the reference signal within the sub-BWP.

A WTRU may determine one or more DFT sizes and/or one or more numbers of clusters for a sub-BWP implicitly, for example, based on one or more properties of the sub-BWP. The one or more properties may include at least one of a subcarrier spacing, a sub-BWP size (e.g., a bandwidth or number of RBs in the sub-BWP), a sub-BWP identity, whether the sub-BWP includes an SSB, or whether the sub-BWP includes a cell-defining SSB. For example, the WTRU may determine a first number of DFT size and/or a first number of clusters for a sub-BWP if the bandwidth (or the number of RBs) for the sub-BWP is larger than a threshold. The WTRU may determine a second number of DFT size and/or a second number of clusters for the BWP if the bandwidth (or the number of RBs) for the sub-BWP is equal to or smaller than the threshold. If a sub-BWP (e.g., the size of the sub-BWP) is larger than a threshold, a larger DFT size and/or a larger number of clusters may be used, for example, to multiplex more WTRUs. If the sub-BWP (e.g., the size of the sub-BWP) is smaller than the threshold, a smaller DFT size and/or a smaller number of clusters may be used, for example, to reduce a PAPR. The WTRU may determine a first number of DFT size and/or a first number of clusters for an initial sub-BWP (e.g., a default sub-BWP), for example, to reduce a PAPR and support better coverage. The WTRU may determine a second number of DFT size and/or a second number of clusters for other sub-BWPs, for example, to multiplex more WTRUs based on at least one property of the sub-BWP and/or a higher layer configuration.

A WTRU may activate or switch (e.g., from activation to deactivation, or vice versa) a BWP (or a sub-BWP) or a sub-BWP based on a different DFT size and/or a different number of clusters. The WTRU may be indicated (e.g., via DCI) to switch from a first BWP or sub-BWP (e.g., a serving BWP or sub-BWP) to a second BWP or sub-BWP (e.g., a target BWP or sub-BWP) for a downlink signal reception and/or an uplink signal transmission. The first BWP (or sub-BWP) and the second BWP (or sub-BWP) may be associated with a same DFT size and/or a same number of clusters. The first BWP (or sub-BWP) and the second BWP (or sub-BWP) may be associated with different DFT sizes and/or different numbers of clusters. One or more of following may apply. The WTRU may determine the length of an activation gap or a switching gap (e.g., a BWP or sub-BWP switching gap) for a BWP or sub-BWP (e.g., the time it takes for the WTRU to transition between an activation of the BWP or sub-BWP to a deactivation of the BWP or sub-BWP, or vice versa) based on whether the DFT sizes and/or numbers of clusters associated with a first BWP (or sub-BWP) and a second BWP (or sub-BWP) are the same. For example, a first switching gap may be used if the first and second BWPs are associated with a same DFT size and/or a same number of clusters, and a second switching gap may be used if the first and second BWPs are associated with different DFT sizes and/or different numbers of clusters.

BWP or sub-BWP switching may be indicated by DCI, which may include a DFT size and/or a number of clusters associated with a target BWP or sub-BWP. For example, an explicit bit field in the DCI may indicate the DFT size and/or the number of clusters. Scheduling information may implicitly indicate a DFT size and/or a number of clusters associated with a BWP or sub-BWP. For example, if an MCS level indicated for PDSCH scheduling in a target BWP or sub-BWP is less than a threshold, a first DFT size and/or a first number of clusters may be used or determined for the BWP or sub-BWP. If the MCS level indicated for the PDSCH scheduling in the target BWP or sub-BWP is equal to or greater than the threshold, a second DFT size and/or a second number of clusters may be used or determined for the BWP or sub-BWP. A frequency domain resource allocation (FDRA) field in the DCI that triggers the BWP or sub-BWP switching may be interpreted (e.g., re-interpreted) as a resource allocation type associated with the target BWP or sub-BWP, for example, if the first DFT size/the first number of clusters is different than the second DFT size/the second number of clusters, respectively.

A scheduling parameter set may be determined based on a BWP and/or a sub-BWP. A WTRU may be scheduled to receive one or more downlink channels and/or reference signals in a BWP (or sub-BWP), and may determine one or more scheduling parameter sets used in the BWP (or sub-BWP) based on an associated DFT size and/or an associated number of clusters for the BWP (or sub-BWP). The scheduling parameter set may include but not limited to an MCS level, a modulation order, a minimum or maximum scheduling bandwidth, a DMRS density, a DMRS pattern, PRG candidates, a frequency resource allocation type, a time resource allocation type, a number of repetitions, a slot aggregation number, a number of slots for a transport block over multi-slot (TBoMS) configuration, or a slot length.

A first set of scheduling parameters may be used for a BWP (or sub-BWP) with a first DFT size and/or a first number of clusters, and a second set of scheduling parameters may be used for a BWP (or sub-BWP) with a second DFT size and/or second number of clusters. The first set of scheduling parameters may include a first subset of modulation order(s) (e.g., binary phase shift keying (BPSK), quadrature phase shift keying (QPSK), etc.), and the second set scheduling parameter may include a second subset of modulation order(s) (e.g., 16QAM (quadrature amplitude modulation), and 64QAM, etc.). As such, if a WTRU is using an active BWP associated with a certain DFT size and/or number of clusters (e.g., the first DFT size and/or the first number of clusters described above), the WTRU may expect to receive a PDSCH transmission with a modulation order (or MCS) that may be within the subset associated the BWP, the DFT size, and/or the number of clusters.

A WTRU may be configured to apply an additional backoff if the WTRU is configured to switch to a different DFT size and/or a different number of clusters. The WTRU may be indicated (e.g., via DCI) to switch from using a first DFT size and/or a first number of clusters to using a second DFT size and/or a first number of clusters for a downlink signal reception and/or an uplink signal transmission. One or more of following may apply. The WTRU may determine a processing time length based on whether the first and second DFT sizes are the same and/or whether the first and second numbers of clusters are the same. For example, a first processing time may be used if the first DFT size/a first number of clusters is the same as the second DFT size/a second number of clusters, respectively, and a second processing time may be used if the first DFT size/the first number of clusters is different from the second DFT size/the second number of clusters, respectively. For example, a first processing time may be used when the first DFT size/a first number of clusters is smaller than (or equal to) the second DFT size/a second number of clusters, respectively, and a second processing time may be used when the first DFT size/the first number of clusters is larger the second DFT size/the second number of clusters, respectively. The processing time may include one or more of following. The processing time may include a time offset between a PDCCH reception and a PDSCH reception (or a PUSCH transmission) with the same or a different sub-carrier spacing (SCS). The processing time may include a time offset between a PDSCH reception and an ACK/NACK with the same or a different SCS. The processing time may include a TCI state indication delay (e.g., indicated by a parameter such as timeDurationForQCL) and/or a TCI state activation delay. The processing time may include a time offset between a PDCCH reception and a CSI report. The processing time may include a time offset between a CSI-RS or CSI-IM (interference management) reception and a CSI report. The processing time may include a secondary cell (Scell) activation delay. The processing time may include a time offset between a PDCCH reception and a reference signal transmission.

A WTRU may be configured with a default DFT size and/or a default number of clusters, for example, for common operations. The WTRU may be configured with a WTRU specific DFT size. The WTRU may determine a DFT size and/or a number of clusters based on a type of channels and/or reference signals (e.g., including an SSB) received or transmitted by the WTRU. For example, if a channel and/or a reference signal is a first type (e.g., a group common signal and/or channel), the WTRU may determine to use a first DFT size and/or a first number of clusters for the channel, the signal, and/or the time/frequency resources associated with the channel or signal. If a channel and/or a signal is a second type (e.g., a WTRU specific signal and/or channel), the WTRU may determine to use a second DFT size and/or a second number of clusters for the channel, the signal, and/or the time/frequency resources associated with the channel or signal. The first type of signals and/or channels (e.g., group common channels or signals) may include one or more of the following: an SSB (e.g., a PSS and/or SSS), a PBCH, a PDCCH detected based on a specific search space type (e.g., a PDCCH detected in a common search space (CSS), a PDCCH detected in one or more of type 1 common CSS without dedicated RRC configuration, type 0 CSS, type 0A CSS, or type 2 CSS), specific types of DCI (e.g., group DCI such as DCI format 2_0, 2_1, etc.), a PUCCH (e.g., all PUCCHs or a PDCCH based on an information type (e.g., information included in the PDCCH)), a PUSCH (e.g., a PUSCH with common information including one or more of MIB, SIBs, or paging, a PUSCH transmitted using a configured grant, a PUSCH scheduled by a fallback DCI such as DCI format 0_0), a PDSCH (e.g., a PDSCH with common information including one or more of a MIB, SIBs, or paging, a PDSCH received using a configured grant, a PDSCH scheduled by a fallback DCI such as DCI format 1_0), a CSI-RS (e.g., a CSI-RS for tracking and/or beam management), a PRACH (e.g., all PRACHs or a PRACH based on a contention type such as a contention based PRACH). The second type of signals and/or channels (e.g., WTRU specific signals or channels) may include one or more of following: a PDSCH (e.g., a dynamically scheduled PDSCH and/or a PDSCH scheduled by non-fallback DCI formats such as DCI formats 1_1 and 1_2), a PUSCH (e.g., a dynamically scheduled PUSCH and/or a PUSCH scheduled by non-fallback DCI formats such as DCI formats 01 and 0_2), a PDCCH detected based on a specific search space type (e.g., a PDCCH detected in a WTRU specific search space, a PDCCH detected in one or more of a type 1 common CSS with dedicated RRC configuration, a type 3 CSS, a WTRU specific search space, etc.), specific types of DCI (e.g., WTRU specific DCI such as DCI format 0_0, 0_1, 1_0, 1_1, etc.), a PUCCH (e.g., all PUCCHs or a PUCCH based on an information type (e.g., information included in the PUCCH)), a CSI-RS (e.g., a CSI-RS for channel state information and/or beam management), an SRS, a PRACH (e.g., all PRACHs or a PRACH based on a specific contention type such as a contention based PRACH). The time/frequency resources described above that may be associated with a channel or signal may include one or more of following: symbols, slots, subframes, RBs, PRBs, RBGs, PRGs, subbands, BWPs, sub-BWPs, etc.

A channel and/or a reference signal (e.g., including an SSB) may be transmitted or received based on N×SC-FDMA and/or clustered DFT-s-OFDM. A WTRU may determine the number of DFTs, BWPs, or sub-BWPs associated with the channel or RS transmission based on an indicated or determined DFT size. For example, the WTRU may determine the number of DFTs based on the following equation.

$${N}_{DFT} = \frac{{N}_{SC}^{RB} \times {N}_{RB}}{{N}_{SC}^{DFT}}$$

where, N_{DFT} may represent the number of DFTs,

$${N}_{SC}^{RB}$$

may represent the number of subcarriers in a RB, N_{RB} may represent the number of RBs in a BWP or a sub-BWP, and

$${N}_{SC}^{DFT}$$

may represent an indicated or determined DFT size. Based on the DFT size and/or the number of DFTs, the WTRU may transmit/receive the channel or RS transmission. For example, the WTRU may apply DFT precoding or inverse DFT (IDFT) precoding within a DFT based on the following equation.

$${y}^{( z )} ( l \cdot {N}_{SC}^{DFT} + k ) = \frac{1}{\sqrt{{N}_{SC}^{DFT}}} {\sum }_{i = 0}^{{N}_{SC}^{DFT} - 1} {\tilde{x}}^{( z )} ( l \cdot {N}_{SC}^{DFT} + i ) {e}^{- j \frac{2 π ik}{{N}_{SC}^{DFT}}}$$

where, k=0, . . . ,

$${N}_{SC}^{DFT} , l = 0 , … , \frac{{M}_{symb}^{layer}}{{N}_{SC}^{DFT}} - 1 , {M}_{symb}^{layer}$$

may represent the number of modulation symbols per layer, and \tilde{x}^{(z)}(i) may represent complex valued modulation symbols for layer z.

The WTRU may transmit/receive a channel or an RS based on one or more of following. The WTRU may transmit/receive the RS or channel based on a DFT index or a cluster index. The WTRU may receive an indication of one or more DFT indexes and/or one or more cluster indexes associated with the RS or channel transmission. The indication may be based on one or more of following. The indication may be based on explicit signaling. For example, the WTRU may receive one or more DFT indexes and/or cluster indexes based on one or more of RRC signaling, a MAC CE, or DCI (e.g., group and/or WTRU specific) signaling. For example, the WTRU may receive a codepoint that may indicate a bitmap of one or more DFT blocks and/or one or more clusters, and the WTRU may transmit/receive the channel and/or RS in the indicated DFT blocks and/or the indicated clusters. The indication may be based on implicit signaling. For example, the WTRU may receive one or more DFT indexes and/or one or more cluster indexes as a part of other signaling. The other signaling may include one or more of following. The other signaling may include a frequency domain resource allocation (FDRA). For example, the one or more DFT indexes and/or the one or more cluster indexes may be indicated with RBs/RBGs for one or more shared channels. The other signaling may include a time domain resource allocation (TDRA). For example, the one or more DFT indexes and/or the one or more cluster indexes may be indicated with time domain resources (e.g., a start symbol, a length, a SLIV, etc.). The other signaling may include a TCI state. For example, the one or more DFT indexes and/or the one or more cluster indexes may be indicated with QCL information for one or more shared channels. The other signaling may include a CORESET or search space (SS). For example, a (e.g., each) CORESET and/or SS may be associated with the one or more DFT indexes and/or the one or more cluster indexes. The WTRU may use the one or more DFT indexes and/or one or more cluster indexes associated with a CORESET and/or an SS if the WTRU receives scheduling via the CORESET and/or the SS.

A WTRU may receive an indication (e.g., via a MAC CE and/or DCI) for activating, triggering, and/or scheduling one or more signals and/or channels (e.g., a PDSCH and/or a PUSCH transmission). The indication may be a separate indication (e.g., independent from other indications) for a DFT index and/or a cluster index. The indication may be a joint indication with an indication for a DFT index and/or a cluster index. The WTRU may transmit/receive one or more signals and/or channels based on information provided via the indication. For example, the WTRU may determine one or more of frequency domain resources, time domain resources, a DMRS pattern, a precoding resource block group (PRG), a scheduling parameter set, etc. based on the information provided via the indication. The indication may include one or more of following. The indication may include a frequency domain resource allocation (FDRA). For example, the WTRU may receive an indication of FDRA (e.g., via DCI) for one or more signals and/or channels. The allocation may be a RBG based allocation. For example, the WTRU may receive a bitmap of RBGs within the indicated DFT blocks and/or the indicated clusters. The RBG size may be scaled based on the number of clusters and/or DFTs. For example, if the WTRU receives an indication of a first number of clusters and/or a first number of DFTs, the WTRU may determine to use a first RBG size. If the WTRU receives an indication of a second number of clusters and/or a second number of DFTs, the WTRU may determine to use a second RBG size. The allocation may be a consecutive RB allocation. For example, the WTRU may receive a starting RB and a length for the signals and/or channels. Based on the starting RB and the length, the WTRU may determine frequency resources for the signals and/or channels. Among the frequency resources, the WTRU may not transmit/receive the signals if a set of resources in the frequency resources includes one or more of a gap between clusters and/or DFTs, one or more SSBs, CORESET #0 and/or SS #0, one or more reserved RBs, one or more PRACH resources, etc. The WTRU may receive multiple pairs of FDRA and one or more (e.g., each) of the FDRA pairs may include a starting RB and a length for the signals and/or channels. One or more (e.g., each) of the multiple pairs may be used to identify a DFT block and/or a cluster for the signals and/or channels. For example, the WTRU may receive multiple starting RBs and a length for the signals and/or channels. The WTRU may identify each starting RB and length to determine frequency resources associated with a DFT block or a cluster for the signals and/or channels. The allocation may be a cluster/DFT block based resource allocation. For example, the WTRU may receive a bitmap of clusters and/or DFT blocks for the signals and/or channels. A cluster size and/or DFT size may be scaled based on WTRU reporting.

A WTRU may be configured to determine an offset (e.g., a minimum offset or gap) between DFT blocks and/or between clusters (e.g., between sub-BWPs of a BWP). For example, a set of frequency resources between DFT blocks and/or between clusters may not be used for transmitting/receiving signals and/or channels. The WTRU may determine the minimum offset based on one or more of a number of DFT blocks, a DFT size (e.g., including frequency resources associated with the DFT size), a number of clusters, or a cluster size (e.g., including frequency resources associated with the DFT size). For example, the WTRU may determine the minimum offset using the following equation:

$$RE {offset}^{general} = \frac{\begin{matrix}Number of RBs \times Number subcarriers per RB - \\ Number of DFT blocks \times DFT size\end{matrix}}{Number of DFT blocks - 1}$$

Ceiling operation or flooring operation may be used if the derived value for the offset is not an integer. The first and the last offset may have different sizes, for example, to cover the whole bandwidth of an active BWP. For example, following equation may be used:

$$RE {offset}^{1 st or last} = Number of RBs \times Number subcarriers per RB \text{} - ( Number of DFT blocks - 2 ) \times RE {offset}^{general}$$

A frequency resource for a minimum offset may not be used for FDRA. For example, REs, RBs, RBGs, subbands, and/or sub-BWPs included in a minimum offset may not be used for FDRA indication (e.g., a WTRU may not transmit/receive signals and/or channels in the frequency resources for the minimum offset). For example, a bitmap of frequency resources (e.g., RBs and/or RBGs) may not indicate frequency resources for the minimum offset, and the WTRU may not transmit/receive signals and/or channels in those frequency resources. For example, the WTRU may receive a configuration of a BWP that may include five RBGs (e.g., a first RBG, a second RBG, a third RBG, a fourth RBG and a fifth RBG). The second RBG and the fourth RBG may be the minimum offset between clusters. Based on the RBGs, the WTRU may receive a 3-bits bitmap (e.g., each bit may correspond to a RBG that may not be for a frequency offset) for scheduling signals/channels. The WTRU may not transmit/receive signals and/or channels in one or more parts of scheduled frequency resources. For example, the WTRU may receive a configuration of a BWP and the BWP may include five RBs (e.g., a first RB, a second RB, a third RB, a fourth RB and a fifth RB), and the second RB and the fourth RB may be the minimum offset between clusters. A base station (e.g., a gNB) may indicate in scheduling information that the first RB is a starting RB and the schedule resources have a length 5 RBs (e.g., the scheduled resources may include the first RB to the fifth RB). In this case, the WTRU may not transmit/receive signals and/or channels in the second RB and the fourth RB as the second RB and the fourth RB may be the minimum offsets between clusters.

A WTRU may determine a precoding resource block group (PRG) (e.g., a PRG size) based on a DFT size and/or a cluster (e.g., sub-BWP) size (e.g., the cluster or sub-BWP size may be determined based on the number of clusters or sub-BWPs configured for the WTRU). Based on the determined PRG (e.g., PRG size), the WTRU may assume that the same precoding may be applied within the PRG. For example, the WTRU may jointly estimate channels by using DMRSs within the PRG. The WTRU may use estimated channels for decoding DL channels and/or signals. The WTRU may apply the same precoding for DMRSs within the PRG to transmit UL channels and/or signals. The WTRU may determine that a DFT size and/or a cluster size (e.g., a sub-BWP size) may be the PRG size for transmitting/receiving channels and/or signals.

The WTRU may receive, e.g., via DCI, an indication of a PRG (e.g., a PRG size) for transmitting or receiving channels and/or signals. If the indicated PRG size is smaller than a DFT size and/or a cluster size (e.g., a sub-BWP size), the WTRU may use the DFT size and/or the cluster size as the PRG size for transmitting/receiving channels and/or signals. If the indicated PRG size is larger than the DFT size and/or the cluster size, the WTRU may use the indicated PRG size as the PRG size.

A WTRU may be scheduled with one or more downlink/uplink channels and/or signals (e.g., reference signals) in a BWP. The WTRU may determine one or more scheduling parameter sets used in the BWP based on the DFT size and/or the number of clusters (e.g., sub-BWPs) used for the BWP. The scheduling parameter sets may include but may not be limited to an MCS level, a modulation order, a minimum/maximum scheduling bandwidth, an RS density, an RS pattern, a frequency resource allocation type, a frequency resource allocation, a time resource allocation type, a time domain resource allocation, a number of repetitions, a repetition type, a slot aggregation number, a number of slots for TBoMS configuration, a periodicity, an offset, and/or a slot length. The WTRU may use a first set of scheduling parameters for channels and/or signals associated with a first DFT size and/or a first number of clusters, and may use a second set of scheduling parameters for channels and/or signals associated with a second DFT size and/or second number of clusters. The first set of scheduling parameters may include a first subset of modulation orders (e.g., BPSK, QPSK, etc.), and the second set scheduling parameter may include a second subset of modulation orders (e.g., 16QAM, 64QAM, etc.). The reference signals may include one or more of an SSB, a DMRS, a CSI-RS, a PT-RS, or SRS.

A WTRU may be configured to determine and/or apply a minimum offset (e.g., frequency offset) between clusters (e.g., sub-BWPs). The WTRU may receive one or more transmit blocks, where a PAPR may be defined based on the ratio of a peak power to an average power in each transmit block. A DFT-s-OFDM may have a lower PAPR compared to a CP-OFDM. The PAPR may be improved based on techniques used in DFT-s-OFDM frequency allocation. For example, a subcarrier mapping may affect the PAPR and, as such, an interleaved subcarrier mapping may achieve a lower PAPR than a localized subcarrier mapping in DFT-s-OFDM.

An output of a spreading module (e.g., DFT) in a DFT-s-OFDM scheme may be used, defined, configured, or determined to be mapped to one or more clusters of resource blocks (RBs) in a BWP. The clusters may be mapped to subsets of the BWP (e.g., to sub-BWPs). One cluster's bandwidth allocation may be mutually exclusive to another cluster's bandwidth allocation. One or more frequency-domain resource allocation techniques may be used to map clusters (e.g., sub-BWPs) to RBs. These frequency-domain resource allocation techniques may be based on scheduling and/or allocating the DFT-s-OFDM clusters to one or more localized or distributed RBs. In an example, a WTRU may determine that the scheduling of clusters is based on localized RBs and, as such, the frequency-domain resource allocation may be based on power efficiency for power-limited WTRUs. In another example, the WTRU may determine that the scheduling of the clusters is based on distributed RBs, where the frequency-domain resource allocation may be based on channel-dependent flexible scheduling.

A WTRU may determine that clusters (e.g., sub-BWPs) are mapped to frequency-domain resources with a minimum offset (e.g., in terms of a number of RBs) between the clusters. For a given combination of a number of clusters and a number of RBs per cluster, the WTRU may determine that the clusters' frequency-domain resource allocation may be performed to minimize a PAPR. One or more of the following may apply. A BWP may be associated with consecutive RBs, to which clusters may be mapped, and the WTRU may determine that the frequency-domain resource allocation per cluster may be distributed based on equal distances between the clusters. A BWP may be associated with non-consecutive RBs, and the BWP may be defined through more than one block of frequency resources with some gaps in between (e.g., due to an SS/PBCH block, CORESET #0, reserved bits, etc.). The WTRU may determine that clusters are distributed throughout such a BWP so that the distance and/or offset (e.g., in terms of a number of RBs) between consecutive clusters may be maximized (e.g., even if the clusters are in separate blocks of the BWP). The WTRU may determine that, if more than one cluster is allocated within a single block of a BWP, the clusters may be scheduled so that they are equally spaced within the corresponding block of the BWP.

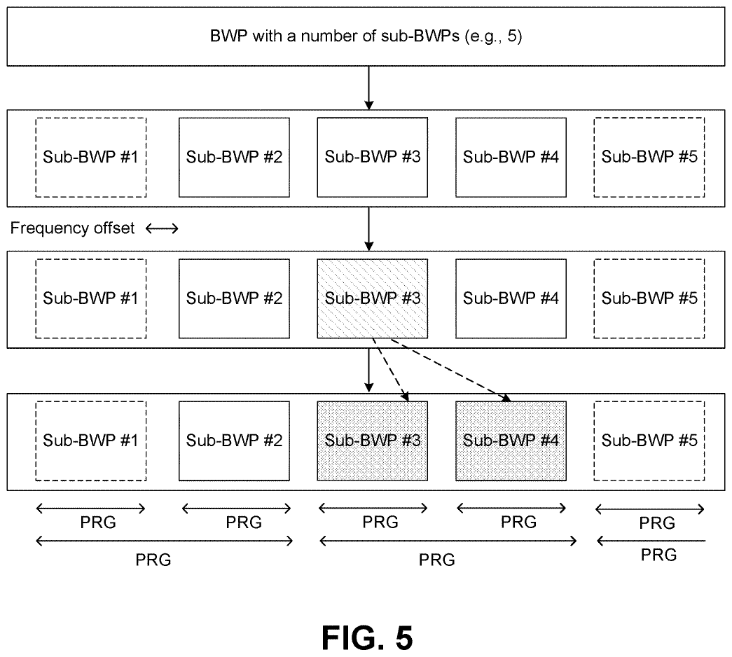

FIG. 5 illustrates the configuration and/or use of one or more sub-BWPs (e.g., the clusters described herein) and/or a PRG for receiving a downlink transmission. A WTRU may receive configuration information regarding a BWP and a number of sub-BWPs associated with the BWP. The configuration information may indicate, for example, that five sub-BWPs are associated with the BWP (e.g., Sub-BWP #1, Sub-BWP #2, Sub-BWP #3, Sub-BWP #4, and Sub-BWP #5 shown in FIG. 5), and/or that one or more of the sub-BWPs may be activated (e.g., the sub-BWPs indicated by solid lines in FIG. 5) or deactivated (e.g., the sub-BWPs indicated by dash-lines). Based at least on the configuration information, the WTRU may determine a frequency offset between a pair of sub-BWPs, respective sizes of the sub-BWPs (e.g., the sub-BWPs may have the same size or different sizes), which may be defined in terms of the number of RBs included in each sub-BWP, and/or respective DFT sizes associated with the sub-BWPs (e.g., the frequency offsets and/or DFT sizes may be the same or may be different). The WTRU may, for example, determine the respective sizes of the sub-BWPs based on the size of the BWP, the number of sub-BWPs associated with the BWP, and/or the frequency offset between a pair of sub-BWPs. Subsequently, the WTRU may receive a DCI (e.g., in one of the sub-BWPs such as Sub-BWP #3) indicating that at least one of the sub-BWPs (e.g., Sub-BWP #3 and/or Sub-BWP #4) may be used for receiving a downlink transmission such as PDSCH transmission, and the WTRU may receive the downlink transmission using the at least one of the sub-BWPs, where the reception may comprise application of an inverse DFT based on the DFT size(s) associated with the at least one of the sub-BWPs.

In examples, the DCI described herein (e.g., or a different DCI) may further indicate a first precoding parameter (e.g., a PRG size) associated with the downlink transmission, and wherein the WTRU may be configured to determine, based at least on the indicated first precoding parameter and the sizes of the sub-BWPs, a second precoding parameter (e.g., a second PRG size) associated with the downlink transmission, and receive the downlink transmission further based on the second precoding parameter (e.g., by performing precoding based on the second precoding parameter). For instance, if the first precoding parameter indicated by the DCI is smaller than a size of one or more of the sub-BWPs (e.g., a maximum size of the sub-BWPs), the WTRU may set the second precoding parameters to the size of the one or more sub-BWPs (e.g., to the maximum size of the sub-BWPs). If the first precoding parameter indicated by the DCI is greater than the size of any of the sub-BWPs (e.g., greater than the maximum size of the sub-BWPs), the WTRU may set the second precoding parameters to be the first precoding parameter indicated by the DCI.

CSI reporting may be performed for N×SC-FDMA and/or clustered DFT-s-OFDM. One or more parameters described herein such as a DFT size, a number of clusters (e.g., sub-BWPs), a cluster size (e.g., sub-BWP size), a number of chunks, a minimum offset between clusters, and/or a waveform type may be referred to as waveform parameters. A specific combination of such parameters may be referred to as a waveform parameter set. A WTRU may determine a waveform parameter set applicable to a CSI report based on explicit signaling such as RRC signaling. For example, a waveform parameter set may be signaled as part of a CSI report configuration. The WTRU may determine a waveform parameter set from a DCI field such as a field associated with aperiodic CSI triggering (e.g., in case of aperiodic CSI reporting or semi-persistent CSI reporting on a PUSCH), or from a MAC CE field (e.g., in case of semi-persistent CSI reporting on a PUCCH). The WTRU may determine a waveform parameter set applicable to a CSI report implicitly, for example, based on a CSI reference resource, a CSI-RS resource, a latest slot, and/or a current waveform. The WTRU may assume that the waveform parameter set may be implicitly determined from at least one of the waveform parameter set used for transmitting PDSCH in a CSI reference resource, the waveform parameter set used for transmitting a CSI-RS resource used for deriving the CSI report, the waveform parameter set used in a downlink slot preceding (e.g., immediately preceding or N slots before) the slot (or sub-slot) in which the CSI report is transmitted, the waveform parameter set indicated as a current waveform parameter set from RRC or MAC CE signaling, etc. The WTRU may determine the waveform parameter set used in a slot or for a transmission based on one or more of the techniques already described. For example, the WTRU may determine a waveform parameter set in a CSI reference resource from a group DCI (e.g., based on a slot format indication).

The WTRU may associate a (e.g., each) waveform parameter set to a power offset and/or to a reference waveform parameter set. The power offset may correspond to a difference of a transmission power backoff between different waveform parameter sets. The WTRU may, e.g., when deriving CSI from a measurement resource such as a CSI-RS transmitted using a first waveform parameter set, derive CSI for a second waveform parameter set assuming that the PDSCH may be transmitted with a power difference corresponding to the difference in power offsets between the first waveform parameter set and the second waveform parameter set. The power offset may depend on at least a pre-coding matrix indicator that may be applied on the PDSCH.

The WTRU may derive a CSI assuming that there may be a waveform parameter set for a CSI reference resource. The WTRU may apply first CSI report configuration parameters in case the WTRU reports CSI for a first waveform parameter set. The WTRU may apply second CSI report configuration parameters in case the WTRU reports CSI for a second waveform parameter set. A waveform parameter set itself may be included as part of the CSI report configuration. The CSI report configuration parameters may include, for example, at least one of the following. The CSI report configuration parameters may include a set of subbands for which to report CSI. For example, each subband may correspond to a frequency range spanned by a chunk, a DFT unit, or a cluster. The CSI report configuration parameters may include a frequency granularity for CQI or PMI (e.g., between a wideband or a subband). The CSI report configuration parameters may include a number of bits for a subband CQI. The CSI report configuration parameters may include a report quantity configuration such as CRI/RI/PMI/CQI or CRI/RI/CQI. The CSI report configuration parameters may include at least one CSI reporting band configuration. Each of the at least one CSI reporting band configuration may correspond to a subset of resources as a function of the clusters, chunks, or DFT sizes. For example, a first CSI reporting band configuration may correspond to a first cluster including odd-numbered resource blocks and a second CSI reporting band configuration may correspond to a second cluster including even-numbered resource blocks. The WTRU may determine a wideband CQI/PMI or subband CQI/PMI for each of the at least one CSI report band configuration. The CSI report configuration parameters may include a subband size, which may be a function of a DFT size and/or a cluster size (e.g., a maximum or minimum DFT size or cluster size). The CSI report configuration parameters may include a CQI table. The CSI report configuration parameters may include a codebook configuration including a codebook subset restriction. The CSI report configuration parameters may include at least one power offset between a CSI-RS and an SSB, or between a CSI-RS and a PDSCH. The CSI report configuration parameters may include at least one power offset relative to a reference waveform parameter set. For example, there may be a first power offset for a transmission over a single chunk, a DFT unit, or a cluster, and a second power offset for a transmission over multiple (e.g., all) chunks, DFT units, or clusters.

The WTRU may determine an applicable waveform parameter set for CSI reporting based on RRC signaling, such as in CSI report configuration information. The WTRU may determine an applicable waveform parameter set based on one or more of the followings. The WTRU may determine an applicable waveform parameter set based on a recommended waveform parameter set. For example, at least one CSI type may include or represent at least one recommended waveform parameter. For example, the at least one CSI type may include at least one of a DFT size, N, a number of clusters (e.g., sub-BWPs), a cluster size (e.g., a sub-BWP size), a number of chunks, or a waveform type. The WTRU may derive a CSI for one or more (e.g., each) of a set of possible waveform parameters. The WTRU may report at least one waveform parameter (e.g., along with other CSI indications such as RI, CQI, PMI, and/or the like). The recommended waveform parameters (or set thereof) may maximize an RI or (in case of same RI) a CQI. In case a CQI has a subband granularity for a waveform parameter set, the maximum CQI among subbands may be utilized for comparison.

The WTRU may determine an applicable waveform parameter set based on a cluster and/or DFT specific CSI reporting and hierarchical measurements. The WTRU may derive a CSI by assuming a set of frequency resources for a (e.g., each) cluster and/or DFT block. For example, the WTRU may be configured with a first cluster and a second cluster. The first cluster and/or DFT block may include a first set of RBs, and the second cluster and/or DFT block may include a second set of RBs in the frequency domain. The WTRU may derive a CSI (e.g., a wideband CSI) for a (e.g., each) cluster and/or a DFT block based on the first set of RBs and/or the second set of RBs. The WTRU may derive a CSI by measuring a different number of frequency resources for a (e.g., each) BWP. For example, the WTRU may measure first frequency resources (e.g., reference signals within a half bandwidth of an active BWP) for a first cluster/DFT block, measure second frequency resources (e.g., reference signals within a quarter bandwidth of an active BWP) for a second cluster/DFT block, measure third frequency resources (e.g., reference signals within ⅛ bandwidth of an active BWP), and so on. The WTRU may report multiple wideband CSIs for multiple (e.g., all) clusters and/or DFT blocks. The WTRU may report its preferred cluster index and/or DFT block index, and/or the corresponding CSI.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive configuration information, wherein the configuration information indicates a bandwidth part (BWP) and a plurality of sub-BWPs associated with the BWP, and wherein the plurality of sub-BWPs includes a first sub-BWP and a second sub-BWP;
determine, based at least on the configuration information, a first sub-BWP size associated with the first sub-BWP and a first discrete Fourier transform (DFT) size associated with the first sub-BWP;
determine, based at least on the configuration information, a second sub-BWP size associated with the second sub-BWP and a second DFT size associated with the second sub-BWP;
receive downlink control information (DCI), wherein the DCI indicates that at least one of the first sub-BWP or the second sub-BWP is to be used for receiving a downlink transmission; and
receive, based on the DCI, the downlink transmission using at least one of the first sub-BWP or the second sub-BWP, wherein the reception of the downlink transmission comprises an application of an inverse DFT based on at least one of the first DFT size or the second DFT size.

17. The WTRU of claim 16, wherein the downlink transmission is received via a single-carrier waveform.

18. The WTRU of claim 17, wherein the single-carrier waveform comprises a single carrier frequency division multiple access (SC-FDMA) waveform or a discrete Fourier transform spread orthogonal frequency division multiplexing (DFT-s-OFDM) waveform.

19. The WTRU of claim 16, wherein the processor is further configured to:
determine a frequency offset between the first sub-BWP and the second sub-BWP, and wherein the first sub-BWP size and the second sub-BWP size are determined further based on the frequency offset.

20. The WTRU of claim 16, wherein the DCI further indicates a first precoding parameter associated with the downlink transmission, and wherein the processor is further configured to:
determine, based at least on the first precoding parameter and at least one of the first sub-BWP size or the second sub-BWP size, a second precoding parameter associated with the downlink transmission.

21. The WTRU of claim 20, wherein the downlink transmission is received further based on the second precoding parameter.

22. The WTRU of claim 20, wherein the first precoding parameter includes a first precoding resource block group (PRG) size, and wherein the second precoding parameter includes a second PRG size.

23. The WTRU of claim 22, wherein the second PRG size is determined to be greater than the first PRG size if the first PRG size is smaller than at least one of the first sub-BWP size or the second sub-BWP size.

24. The WTRU of claim 20, wherein the processor is further configured to receive a radio resource control (RRC) message regarding the first precoding parameter.

25. The WTRU of claim 16, wherein the processor is further configured to determine a timing parameter associated with the first sub-BWP or the second sub-BWP, the timing parameter being associated with at least one of a channel state information (CSI) report associated with the first sub-BWP or the second sub-BWP, a reference signal associated with the first sub-BWP or the second sub-BWP, a hybrid automatic repeat request (HARQ) feedback associated with the first sub-BWP or the second sub-BWP, or a transmission configuration indication (TCI) indication associated with the first sub-BWP or the second sub-BWP.

26. A method, the method comprising:
receiving configuration information, wherein the configuration information indicates a bandwidth part (BWP) and a plurality of sub-BWPs associated with the BWP, and wherein the plurality of sub-BWPs includes a first sub-BWP and a second sub-BWP;
determining, based at least on the configuration information, a first sub-BWP size associated with the first sub-BWP and a first discrete Fourier transform (DFT) size associated with the first sub-BWP;
determining, based at least on the configuration information, a second sub-BWP size associated with the second sub-BWP and a second DFT size associated with the second sub-BWP;
receiving downlink control information (DCI), wherein the DCI indicates that at least one of the first sub-BWP or the second sub-BWP is to be used for receiving a downlink transmission; and
receiving, based on the DCI, the downlink transmission using at least one of the first sub-BWP or the second sub-BWP, wherein the reception of the downlink transmission comprises an application of an inverse DFT based on at least one of the first DFT size or the second DFT size.

27. The method of claim 26, wherein the downlink transmission is received via a single-carrier waveform, and wherein the downlink transmission is received using a single carrier frequency division multiple access (SC-FDMA) technique or a discrete Fourier transform spread orthogonal frequency division multiplexing (DFT-s-OFDM) technique.

28. The method of claim 26, wherein the DCI further indicates a first precoding parameter associated with the downlink transmission, and wherein the method further comprises:
determining, based at least on the first precoding parameter and at least one of the first sub-BWP size or the second sub-BWP size, a second precoding parameter associated with the downlink transmission.

29. The method of claim 28, wherein the downlink transmission is received further based on the second precoding parameter.

30. The method of claim 28, wherein the first precoding parameter includes a first precoding resource block group (PRG) size, the second precoding parameter includes a second PRG size, and the second PRG size is determined to be greater than the first PRG size if the first PRG size is smaller than at least one of the first sub-BWP size or the second sub-BWP size.
